(19) United States
(12) Patent Application Publication
(10) Pub. No.: US 2018/0010374 A1
(43) Pub. Date: Jan. 11, 2018

(54) MOVABLE PANE WITH BIASED RETAINER

(71) Applicant: Dura Operating, LLC, Auburn Hills, MI (US)

(72) Inventors: Ronnie G. Gipson, Metamora, MI (US); Scott S. Sharron, LaSalle (CA)

(21) Appl. No.: 15/205,626

(22) Filed: Jul. 8, 2016

(51) Int. Cl. E05D 15/06; B60J 1/18

(52) U.S. Cl. CPC E05D 15/0686; B60J 1/1853; E05Y 2600/628; E05Y 2600/14; E05Y 2900/55; E05Y 2600/45

(57) ABSTRACT

In at least some implementations, a window assembly for a motor vehicle includes a guide rail having at least one wall that defines at least part of a guide track, a movable pane associated with the guide rail and movable relative to the guide track along a path of movement defined by and between a closed position and a fully open position, and a retainer. The retainer may be coupled to the movable pane and be movable with the movable pane, and be located at least partially within the guide track. The retainer may further include at least one biasing member that is engaged with the wall along the path of movement to limit movement of the retainer relative to the guide rail.

### TECHNICAL FIELD

The present disclosure relates to a movable window pane for use in a motor vehicle and a retainer for the movable pane.

### BACKGROUND

Motor vehicle window assemblies having one or more movable panes may be either manually operated or operated by an electric motor. Such window assemblies are used, for example, as rear slider windows for pick-up truck cabs, and may have a frame in which are mounted one or more movable panes along with one or more fixed panes. The frame may include or carry a guide rail that defines a guide track in which the movable pane is reciprocated between open and closed positions. The movable pane may be carried by a retainer received in the drive track. To prevent undue friction between the retainer and the guide rail that would hinder movement of the movable pane, the retainer is somewhat loosely received in the guide rail. Hence, the retainer and movable pane may move relative to the guide rail which can cause, among other things, noise and vibrations, and reduced sealing force between the movable pane and one or more seals.

### SUMMARY

In at least some implementations, a window assembly for a motor vehicle includes a guide rail having at least one wall that defines at least part of a guide track, a movable pane associated with the guide rail and movable relative to the guide track along a path of movement defined by and between a closed position and a fully open position, and a retainer. The retainer may be coupled to the movable pane and be movable with the movable pane, and be located at least partially within the guide track. The retainer may further include at least one biasing member that is engaged with the wall along the path of movement to limit movement of the retainer relative to the guide rail.

In at least some implementations, a window assembly for a motor vehicle includes a guide rail, a movable pane and a retainer. The guide rail has a guide track defined at least in part by opposed side walls and an upwardly facing surface disposed between the side walls. The movable pane is associated with the guide rail and movable in the guide track along a path of movement defined by and between a closed position and a fully open position. The retainer is coupled to the movable pane and movable with the movable pane, the retainer being located at least partially within the guide track and moveable along the guide track. The retainer is received between the side walls of the guide rail and has at least one biasing member that is engaged with one side wall or the upwardly facing surface along at least part of the path of movement to limit movement of the retainer relative to the guide rail.

In at least some implementations, a retainer for a movable pane of a window assembly includes a body having an upper surface, a lower surface and a pair of opposed side walls extending vertically between the upper surface and lower surface and longitudinally along at least a portion of a length of the body, and a pair of legs extending from the lower surface and including at least one laterally extending foot spaced from the lower surface. The body includes a cavity formed in at least one of the upper surface and the lower surface, the cavity adapted to receive part of the movable pane and being defined by a pair of longitudinally and vertically extending side walls and a pair of laterally and vertically extending end walls connected to the side walls. A biasing member is connected to the body and extends away from a portion of the body to which the biasing member is connected. The biasing member is flexible and resilient and adapted to engage a guide rail of the window assembly and to resiliently flex toward the portion of the body to which the biasing member is connected.

Other embodiments can be derived from combinations of the above and those from the embodiments shown in the drawings and the descriptions that follow.

### BRIEF DESCRIPTION OF THE DRAWINGS

The following detailed description of preferred implementations and best mode will be set forth with regard to the accompanying drawings, in which:

FIG. 1 is a perspective view of the interior side of a window assembly for a motor vehicle;

FIG. 2 is an enlarged perspective view of a portion of the interior side of the window assembly with a movable pane removed to show a retainer;

FIG. 3 a sectional view of a window assembly showing a portion of a movable window, a guide rail and a retainer;

FIG. 4 is a perspective view of a portion of a guide rail and retainer of the window assembly;

FIG. 5 is a perspective view of a portion of a retainer of the window assembly;

FIG. 6 is a perspective view of a portion of a retainer of the window assembly;

FIG. 7 is a perspective view of a portion of a retainer of the window assembly;

FIG. 8 is a sectional view of a window assembly showing a portion of a movable window, a guide rail and a retainer; and

FIG. 9 is a perspective view of a portion of a retainer of the window assembly.

### DETAILED DESCRIPTION

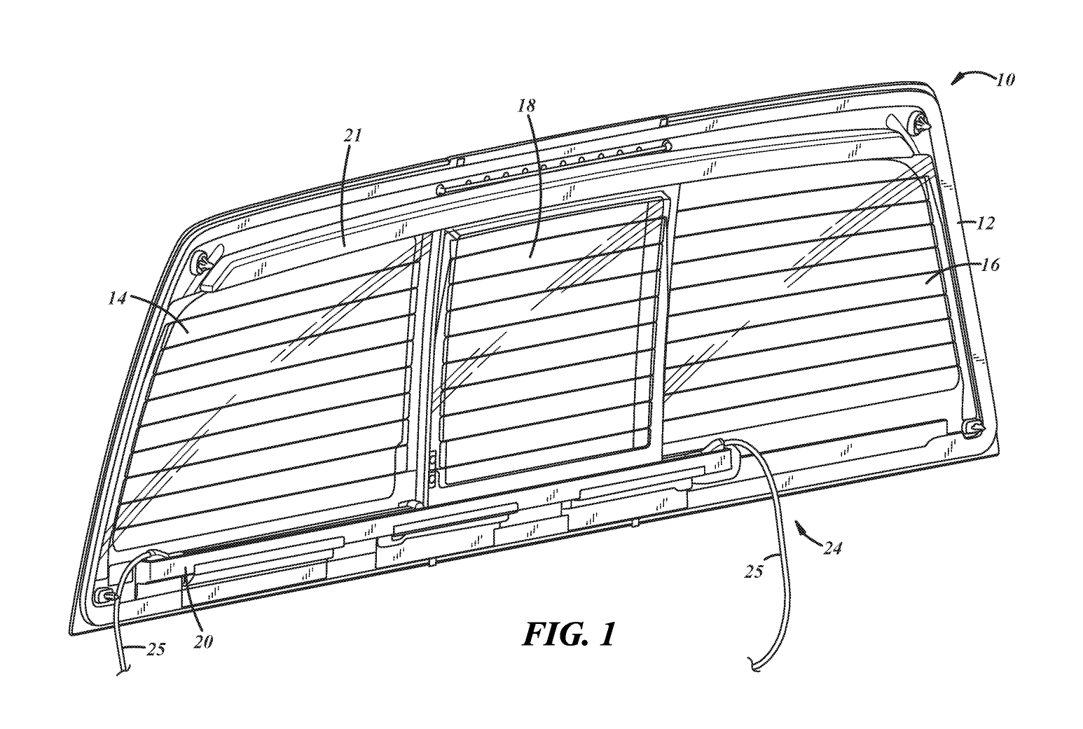

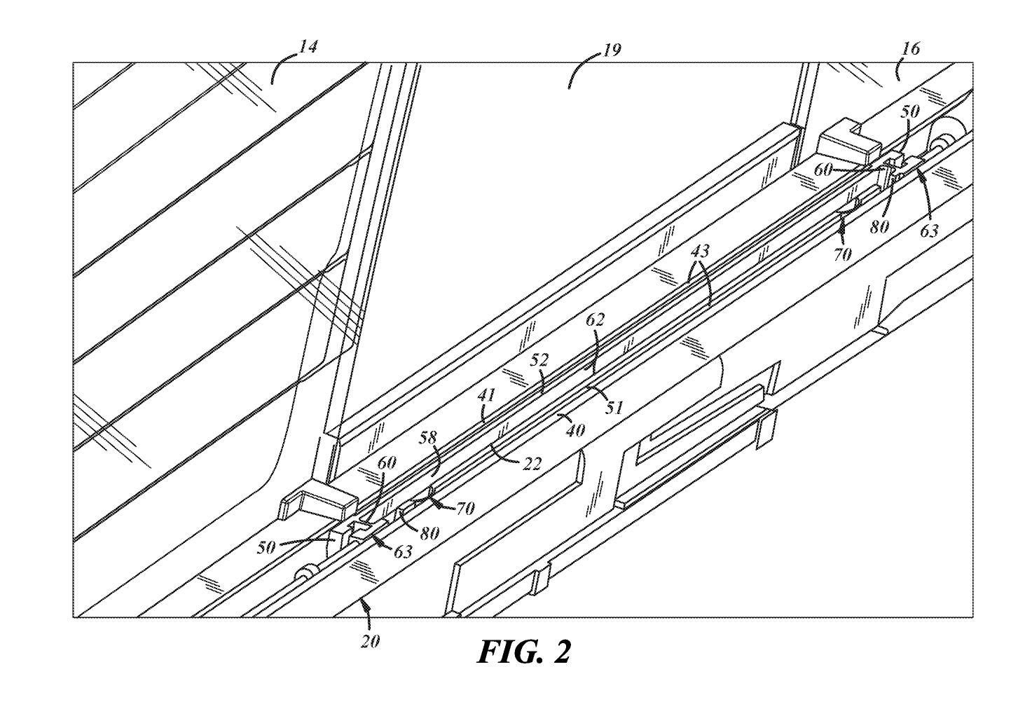

Referring in more detail to the drawings, FIG. 1 illustrates a window assembly 10 viewed from a forward or interior facing side. The illustrated window assembly 10 includes a frame 12 partially or fully surrounding, or otherwise retaining one or more fixed panes or panels (two fixed panes 14, 16 are shown in the illustrated example) and a movable pane or panel 18 that, in use, is moved relative to the fixed pane(s) 14, 16 to expose or cover up an opening 19 (FIG. 2) between the fixed panes. A lower guide rail 20 may be located along the bottom of the frame 12, and an upper guide rail 21 may be located along the top of the frame 12. The lower and upper guide rails 20, 21 may be connected to the frame or otherwise positioned near the frame 12 and the movable pane 18. A cradle or retainer 22 may be received at least partially within either or both of the lower and upper guide rails 20, 21 and may receive part of the movable pane 18. A cable drive assembly 24 including cables 25 is connected to the retainer 22 to enable powered movement of the movable pane, although the movable pane 18 could instead be manually movable as is known in the art.

The movable pane 18 is positioned, in its closed position, between the left and right fixed panes 14, 16. The movable pane 18 and the left and right fixed panes 14, 16 are mounted in or to the frame 12. The frame 12 may include at least one unitary, full circumference member extending around the perimeter of panes 14-18, if desired, or it may be made up of separate components coupled together, and the frame need not extend around the entire perimeter. The frame 12 can be formed by injection molding in place around the fixed position panes and can be formed of any suitable material such as, for example, one or more plastics.

The fixed panes 14, 16 are secured to the circumferential frame 12 such that they remain in their fixed positions. The fixed panes 14, 16 can be molded to, bonded to or secured to the circumferential frame 12 in any other suitable manner. The fixed panes 14, 16 can be formed of any suitable material such as, for example glass or plastic. The fixed panes 14, 16 are typically transparent but alternatively can be translucent or opaque.

The movable pane 18 travels between a closed position wherein the opening located between the fixed panes 14, 16 is completely closed by the movable pane 18 (shown in FIG. 1) and an open position wherein the movable pane 18 at least partially overlays one of the fixed panes 14, 16 in order to expose at least a portion of the opening 19 located between the fixed panes 14, 16. The movable pane 18 can be formed of any suitable material such as, for example glass or plastic. The movable pane 18 is typically transparent but alternatively can be translucent or opaque. The top of the movable pane 18 may be guided in its lateral movement within the upper guide rail 21 and the bottom of the movable pane 18 may be guided in its lateral movement within the lower guide rail 20.

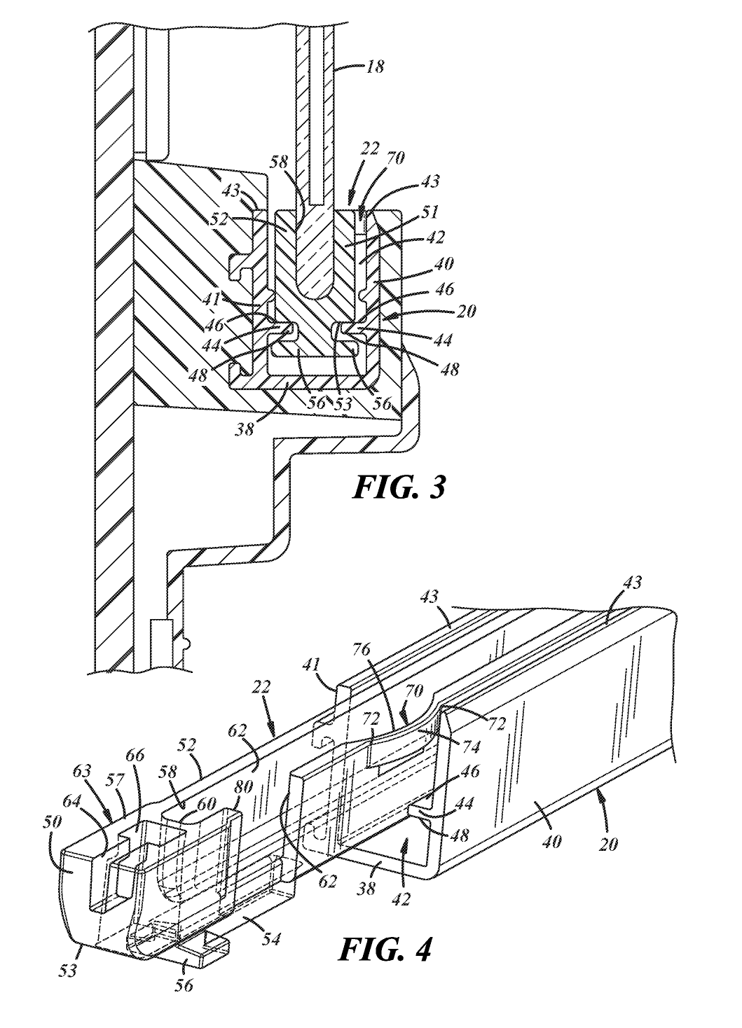

As best shown in FIGS. 3 and 4, the lower guide rail 20 has a horizontal and longitudinally extending lower wall 38, and vertical and longitudinally extending forward and rearward side walls 40, 41 extending upwardly to an upper surface 43 from the forward and rear edges of the bottom wall 38 to form a longitudinally extending channel 42. A pair of horizontal, opposed flanges 44 extend laterally inwardly toward each other from the side walls 40, 41 above the lower wall 38 and within the channel 42. The inner edges of the flanges 44 may be spaced apart to form a longitudinally extending gap or space therebetween. The flanges 44 may be at the same height and their upper surfaces 46, 48 may cooperate to form a support surface for the retainer 22 and movable pane 18 as described in more detail hereinafter. The flanges 44 may extend substantially the entire longitudinal length of the lower guide rail 20 to support the retainer 22 and movable pane 18 along all or most of the path of travel of the movable pane relative to the guide rail 20. The lower guide rail 20 may conveniently be formed by extrusion and can comprise any suitable material such as a plastic or metal.

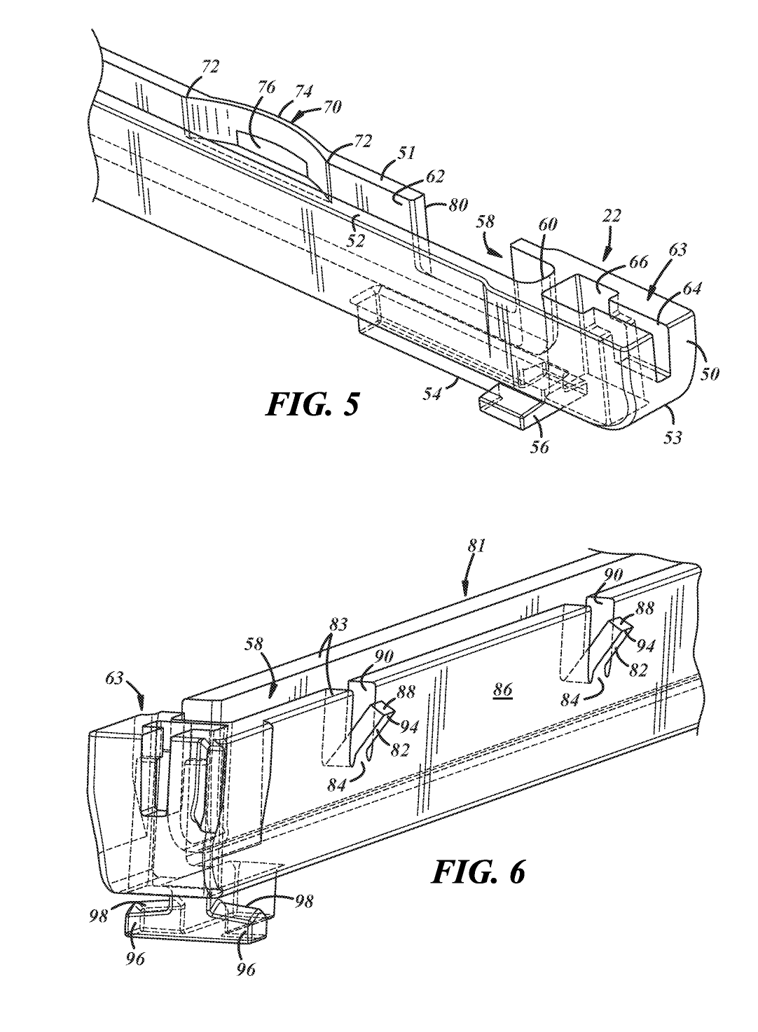

As best shown in FIG. 2, the retainer 22 may be defined by a body that has a longitudinal length between its ends 50 equal to or greater than the length of the movable pane 18, and a lateral width between longitudinally and vertically extending side walls 51, 52 so that the retainer may fit between the side walls 40, 41 of the lower guide rail 20. A lower surface 53 (FIGS. 3-5) of the retainer 22 may be generally planar (or otherwise constructed as desired to cooperate with flange 44) and sized to engage the upper surfaces 46 of the guide rail flanges 44 so that the retainer 22 is supported by the flanges 44 and is longitudinally slidable along the flanges 44 within the channel 42. The lower surface 53 may be continuous and engage the flanges along the length of the retainer 22, or the lower surface may be discontinuous and provide discrete, spaced apart points or regions of contact with the flanges, as desired. The side walls 51, 52 extend vertically to an upper surface 57 that may be flush with or recessed below the upper surface 43 of the side walls 41, 42 of the guide rail 20.

The retainer 22 may physically overlap part of and/or be secured to the lower guide rail 20 to limit vertical movement of the retainer 22 relative to the lower guide rail 20. The illustrated retainer 22 is provided with a pair of legs 54 located near each end of the retainer 22 (or otherwise located along the retainer), and each leg includes at least one laterally extending foot 56. The legs 54 are spaced apart from the lower surface 53 of the retainer 22 a distance adequate to receive the flanges 44 of the lower guide rail 20 between the lower surface 53 and the foot 56 or feet of each leg 54. The illustrated legs 54 are spaced apart from the lower surface 53 a distance that permits limited movement of the retainer 22 relative to the lower guide rail 20 but prevents further vertical movement of the retainer 22 when the feet 56 engage the lower surfaces 48 of the flanges 44. The illustrated legs 54 are located near the ends of the retainer 22 and extend for a limited length but alternatively can extend for a greater portion of the length of the retainer 22 up to and including the full length of the retainer (e.g. one long leg) or be otherwise located along the retainer, and more than two legs may be provided. One or both of the retainer 22 and the lower guide rail 20 are preferably formed of a resilient material so that the retainer 22 can be snap-fit into the lower guide rail 20 by pushing the retainer 22 into the channel 42 as one or both of the flanges 44 and the feet 56 deflect to permit the feet 56 to pass below the flanges 44 and then resiliently snap back into their interfering position to limit vertical movement of the retainer 22 relative to the lower guide rail 20. It is noted that the retainer 22 alternatively can be inserted into the lower guide rail 20 by longitudinally sliding the retainer into the channel 42 from one of the ends of the channel 42.

The upper surface 57 of the retainer 22 may have a central slot or cavity 58 formed therein which may be closed at its ends. The cavity 58 is sized to receive the bottom portion of the movable pane 18 therein. In at least some forms, the cavity 58 may include two laterally and vertically extending end walls 60 at opposite ends of the cavity, each facing a peripheral edge of the movable pane 18. The end walls 60 may be interconnected by a pair of vertically and longitudinally extending side walls 62, each side wall 62 extending along and facing an opposed face of the movable pane 18. The cavity 58 can be sized to form a tight or interference fit with the movable pane 18 to retain the movable pane 18 in the cavity 58 via friction. For example, the cavity 58 may have a slot of about 3.8 mils in width when the movable pane 18 has a thickness of about 4 mils. The movable pane 18 may be more loosely received in the retainer 22, or it may be coupled to the retainer by an adhesive or the like.

Each end of the retainer 22 may include a connector 63 to couple the drive cables 25 to the retainer and facilitate powered movement of the movable pane 18 back and forth within the guide rail 20. Each connector 63 may be sized to receive a cable fitting (e.g. a ferrule or a ball) as described in more detail hereinafter. The connector 63 widens from a slot 64 sized to closely receive a cable core to a larger opening or cavity 66 sized to snugly receive the cable end fitting. The retainer 22 can comprise any suitable material such as a plastic or metal. A suitable plastic is believed to be DELRIN commercially available from the Dupont Corporation.

As shown in FIGS. 1-5, the retainer 22 may include at least one biasing member 70 that extends outwardly from the retainer and is adapted to engage the guide rail 20 when the retainer 22 is received within the channel 42. The biasing member 70 may also urge an opposed surface of the retainer 22 into contact with the guide rail 20 so that multiple points or areas of the retainer are engaged with the guide rail at the same time. For example, a biasing member 70 may extend away from an adjacent portion of the retainer 22 not including the biasing member and toward an adjacent portion of the guide rail 20.

In the example of FIGS. 1-5, multiple biasing members 70 are provided along the longitudinal length of the retainer 22. The biasing members 70 are shown as being of the same design, for example, the same size, shape and orientation, although other arrangements may be used. In this example, the biasing members are arcuate and extend laterally away from the movable pane 18 (e.g. away from the slot in which the pane is received) and toward a side wall 40 of the guide rail 20. Ends 72 of the biasing members 70 merge with or are otherwise coupled to a side wall 51 of the retainer 22 and a mid portion 74 that is laterally spaced from the ends 72, is arranged to engage the guide rail side wall 40 such as by being outwardly bowed away from the cavity to engage a contact surface (e.g. a portion of the exterior surface of the biasing member) with the guide rail. The mid portion 74 may have a vertical height (dimension perpendicular to the lateral width of the retainer) to provide a desired contact surface area with the guide rail 20. The height of the biasing member 70 may be between 5% and 100% of the height of the retainer side wall 51 and may include and define part of the upper surface 57, if desired, or be spaced below the upper surface 57 and/or spaced above the lower surface 53 of the retainer. Further, the biasing member 70 may have a lateral thickness of any desired dimension to provide a desired strength, flexibility and resilience. A gap 76 may be provided between at least part of the mid portion 74 and the retainer side wall 51 to facilitate flexing of the mid portion 74 relative to the retainer side wall 51. Instead of being attached at both ends 72, the biasing member 70 could be connected at one end to the retainer 22 and its other end may be unattached.

In at least some implementations, at least when the movable pane 18 is not moving, the mid portion 74 of the biasing member 70 contacts the side wall 40 but the adjacent portion of the retainer side wall 51 from which the biasing member 70 extends does not engage the retainer side wall 40. When engaged with the guide rail 20, the biasing member 70 provides a force on the guide rail and biases the retainer 22 away from the side wall 40 of the guide rail engaged by the biasing member 70. In the example shown, the biasing member 70 engages one side wall 40 of the guide rail 20 and this biases the retainer 22, or at least a portion thereof, toward and into engagement with the opposite side wall 41 of the guide rail. In this example, the biasing member 70 laterally biases the retainer 22 into engagement with the side wall 41, but other arrangements are possible, some examples of which are noted below.

Further, as noted above, the biasing member 70 in this example is comprised of a strip of the same material that forms the retainer 22, and the biasing member 70 is formed at the same time as the remainder of the retainer to facilitate forming the retainer and biasing member. Further, the retainer 22 and biasing member 70 may be formed from one homogenous piece of material, or the biasing member or other features of the retainer may be formed at least partially of one material that is overmolded by another material when the retainer is formed. In either case the biasing member 70 is considered to be integral with the retainer 22 in that the biasing member is a feature of the retainer that is formed when the remainder of the retainer is formed. The biasing member 70 could be otherwise formed, and may be formed separately from the retainer 22 and attached thereto if desired.

The biasing member 70 may be flexible and resilient so that the biasing member may flex in use and permit some lateral movement of the retainer 22 relative to the guide rail 20 while maintaining contact with the guide rail throughout a majority and up to all of the range of movement of the movable pane 18. In at least some implementations, the retainer 22 remains engaged with both of the guide rail side walls 40, 41 throughout movement of the movable pane 18 along its entire path of movement. In more detail, the biasing member 70 engages one side wall 40 with a laterally opposite portion of the retainer 22 engages the laterally opposed side wall 41.

This may reduce noise and vibrations that might otherwise be caused by unrestrained or less restrained movement of the retainer 22 relative to the guide rail 20 (e.g. a rattle). Further, the engagement of the biasing member(s) 70 with the guide rail 20 may provide a desired resistance to movement of the retainer 22 and hence, the movable pane 18, relative to the guide rail for more uniform and controlled movement of the window, and less opportunity for the retainer to become skewed or angled relative to the guide track which may cause the retainer to bind or otherwise require an uneven force be applied to move the movable pane 18 along its path of the movement. While described above with a drive assembly 24 that is powered to automatically move the movable pane 18 between its open and closed positions, the retainer 22, guide rail 20 and other components may be used with a window pane that is manually moved between its open and closed positions, and the uneven force needed to move window pane carried by a retainer that is received more loosely in the guide rail 20 may be undesirable.

The retainer 22 may also include one or more openings 80 therein arranged to allow water or other fluid flow out of the cavity 58 and to the guide rail 20. In the form shown in FIGS. 1-5, the openings 80 include a slot in a side wall 62 of the retainer 22. The openings 80 may extend to the bottom of the cavity 58 to facilitate draining the cavity of any fluid that may enter the cavity, as well as solid contaminants (e.g. dirt, dust or other). The openings 80 may be positioned as desired relative to the biasing members 70. In at least some implementations, the biasing members 70 are provided on a side wall 51 of the retainer 22 that faces inwardly and is adjacent to guide rail side wall 40. This urges the retainer 22 outwardly, toward the guide rail side wall 41 that is closer to the vehicle exterior and away from the guide rail side wall 40 adjacent to or facing toward the vehicle interior. Corresponding drain openings may be provided in the guide rail 20, and the drain openings may desirably be positioned adjacent to the vehicle exterior to limit drainage toward or into the vehicle interior. Hence, the fluid handling and drainage may occur at the side of the retainer 22 and guide rail 20 that is closest to the vehicle exterior. Further, the biasing members 70 may yieldably bias the retainer 22 toward the exterior the side wall 41 of guide rail 20 to facilitate this drainage path and to limit the contaminants that might enter the guide rail from the exterior (e.g. when the window is open or around a window seal).

As shown in FIG. 6, a retainer 81 may include one or more biasing members 82 may be defined by a cantilevered finger that extends from a base 84 attached to the retainer side wall 86 to a free end 88 spaced laterally outwardly from the base 84 and from the retainer side wall 86. One or more biasing members 82 may extend from either or both retainer side walls 86, as desired. The retainer 81 may include a slot 90 adjacent to and longitudinally aligned with each biasing member 82, provide a gap or space into which the biasing member 82 may move as the biasing members flex under an opposed force. The slot may start at the upper surface 83 of the retainer 81 and extend downwardly to the base 84 of the biasing member 82. A contact surface 94 may be defined at the laterally outermost portion of the biasing member 82, where the finger engages the guide rail side wall 40, and this contact surface may be spaced from the lower wall of the retainer and closer to the upper surface 83 than the lower surface, if and as desired. The biasing member 82 may flex laterally toward the cavity 58 and is resilient to maintain a biasing force against the guide rail 20 to yieldably bias the retainer 81 against the opposed side wall 41, as noted above with regard to the biasing members 70 shown in FIGS. 1-5. In the example shown, the biasing members 82 are vertically longer than they are longitudinally wide or laterally thick, although other arrangements may be used and the fingers may have any desired combination of vertical, longitudinal and lateral dimensions. The biasing member(s) 82 may be integrally formed at least in part from the same material and at the same time as the rest of the retainer 81, may be overmolded when the retainer is formed, or may be a separate component attached or otherwise carried by the retainer in assembly, as desired.

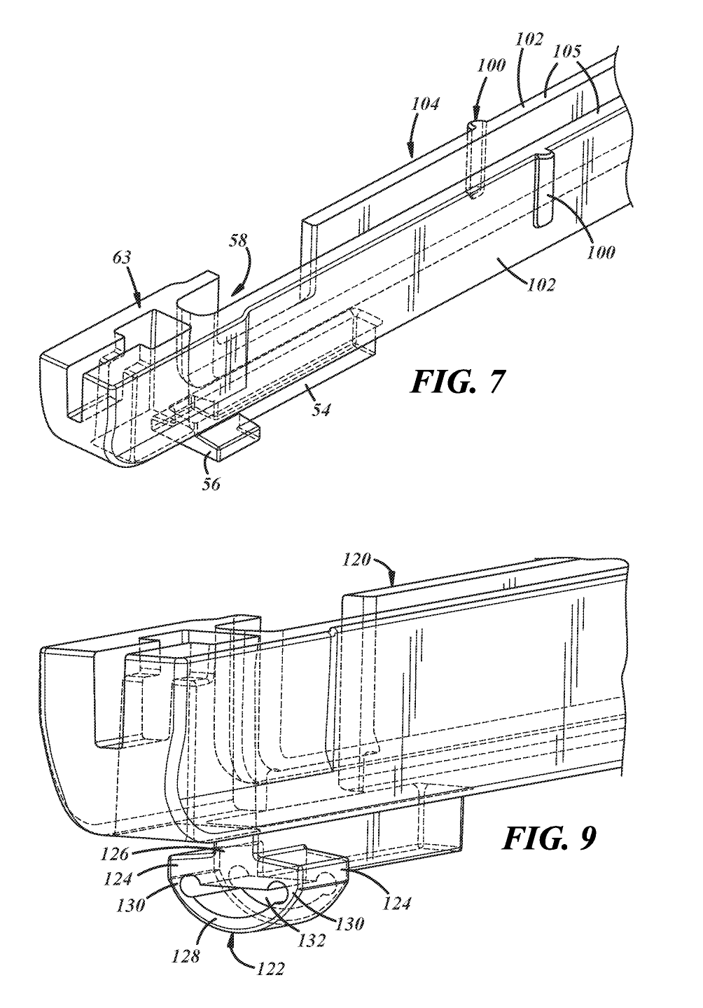

The implementation of FIG. 7 includes biasing members 100 that extend laterally outwardly from both side walls 102 of the retainer 104. The biasing members 100 include outwardly extending nubs that are adapted to engage the guide rail 20 and provide a contact surface (portion of the outwardly facing or exterior surface that engages the guide rail) that provides a reduced surface area of contact with the guide rails. The biasing members 100 could be somewhat yieldable and resilient to provide some limited lateral flexing or compression in use, as desired. The biasing members 100 may remain in contact with the guide rail 20 in all positions of the movable pane 18, if desired, to limit or prevent disengagement of the retainer 104 from the guide rail which could result in undesirable vibrations and noise. The biasing members 100 are shown as being partial cylinders that extend vertically along a majority of the height of the retainer side walls 102, starting at and defining part of the upper surface 105 of the retainer 104 and having a vertical length that is greater than the longitudinal and lateral dimensions of the biasing member, although other shapes and sizes of biasing members may be used, as desired. In this example, there is no gap in the retainer side walls 102 for, or associated with, the biasing members 100, as set forth with regard to the embodiments of FIGS. 1-5 and FIG. 6.

The biasing members 70, 82, 100 of FIGS. 1-7 have each acted laterally, and generally perpendicular to the longitudinal travel of the movable pane, and the longitudinally extending guide rail side walls 40, 41. These biasing members bias the retainer into engagement with vertically oriented and laterally facing walls 40, 41 of the guide rail 20. In FIGS. 6, 8 and 9, biasing members are shown that act vertically, to vertically bias the retainer into vertically facing walls of the guide rail. In the example shown, the guide rail flanges 44 have vertically facing upper and lower surfaces 46, 48. The upper and lower surfaces 46, 48 of the flanges 44 are at least partially laterally overlapped by the retainer lower surface and the laterally extending feet. Hence, biasing members could be provided extending vertically from either the lower surface or the feet for engagement with the adjacent upper or lower surface of one or both flanges.

For example, in FIG. 6, the retainer 81 may include one or more feet 96 that have rounded, upwardly extending biasing members 98 that engage the guide rail flanges 44 to vertically bias the retainer 81 downwardly onto flange upper surfaces 46. The biasing members 98 and/or feet 96 may be flexible and resilient to yieldably bias the retainer onto the flange upper surfaces 46 without creating an undesired frictional engagement between the retainer 81 and guide rail 20.

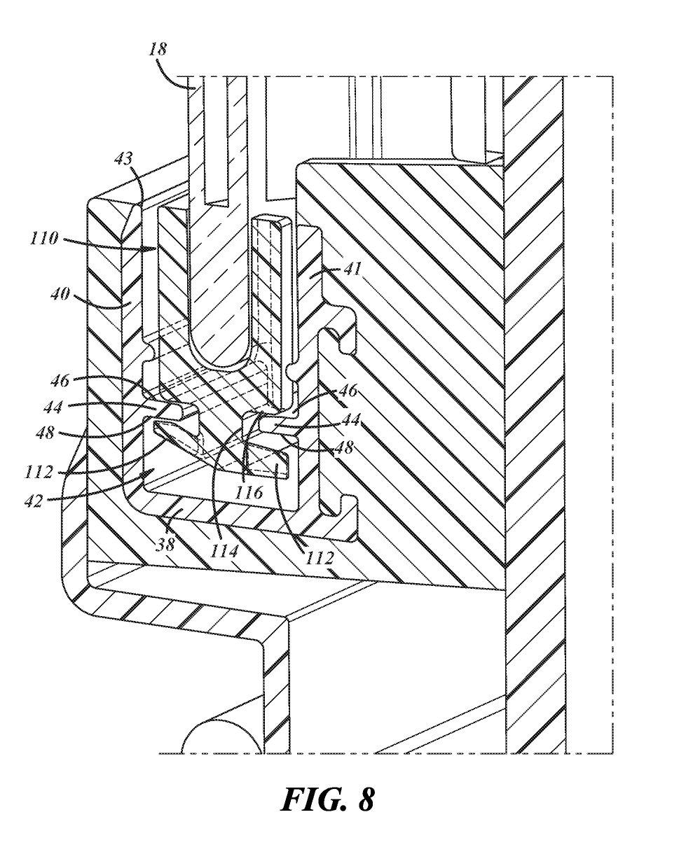

In the example shown in FIG. 8, the retainer 110 includes two feet 112 that are provided on each leg 114, with one foot 112 extending laterally outwardly from opposed sides of each leg 114. One foot 112 is inclined vertically to provide a contact surface that engages the lower surface 48 of one flange 44. The other foot 112 is shown as extending laterally and not normally engaged with the adjacent flange 44, but the other foot could likewise be inclined to engage the lower surface of its corresponding flange, if desired. Here, the inclined foot 112 acts as a biasing member and yieldably biases the retainer 110 downwardly relative to the guide rail 20, so that the lower surface 116 of the retainer 110 normally engages the upper surface 46 of the flanges 44 (where normally means in the absence of a force stronger than the combined biasing force and the weight of the movable pane and retainer, which would lift the retainer and movable pane off of the flanges). The biasing member 112 may remain engaged with the flange 44 throughout movement of the retainer 110 relative to the guide rail 20 (e.g. throughout the path of movement of the movable pane 18). This may prevent or substantially inhibit separation of the foot 112 and flange 44 which can cause rattling or other noise and vibration between the retainer and guide rail 20. The vertically acting biasing member 112 may be used instead of or in combination with other biasing members, including the laterally acting biasing members 70, 82, 100 noted above.

In FIG. 9, a retainer 120 includes a vertically acting biasing member 122 that extends downwardly from and is coupled to the feet 124. While shown as being coupled to both feet 124, the biasing member 122 could instead extend from one foot, or from the leg 126 between the feet. The biasing member 122 may include a strip of flexible and resilient material separated from the leg 126 and feet 124 along a mid portion 128 between the ends 130 with a gap 132 between the mid portion 128 and feet 124. Hence, the mid portion 128 may define a contact surface that engages the guide rail and flexes vertically toward and away from the leg 126 and provide a vertical biasing force on the retainer 120. The biasing member 122 has a lateral width, a longitudinal length and a thickness in the vertical direction to provide a desired flexibility, resilience and strength. In the example shown, the length of the biasing member 122 is less than the length of the leg 126, and only a portion of the length of the retainer 120, although the biasing member could be of any desired length.

At least a portion of the biasing member 122 is arranged to engage the lower surface 38 of the guide rail 20, which is generally opposed to the lower flange surfaces 48. The biasing member 122 thus biases the feet 124 upwardly toward the lower flange surfaces 48, against the force of gravity acting on the retainer 120 and movable pane 18. Under the force of the biasing members 122, the feet 124 may engage and be maintained in engagement with the lower flange surfaces 48, if desired. Otherwise, a retainer lower surface 134 may engage the upper flange surfaces 46 while the biasing members 122 engage the lower surface 38 of the guide rail 20 to damp vibrations and limit or prevent relative vertical movement of the retainer 120 within the guide rail 20.

While several forms of vertically acting biasing members have been specifically shown, other arrangements are possible. For example, one or more biasing members may extend downwardly from the retainer to engage the flange upper surface(s) 46. Of course, still other arrangements are possible, and different forms of vertical biasing members may be used instead of or in combination with other vertical and/or lateral biasing members. By way of another non-limiting example, a laterally acting biasing member may extend from the leg or one or both feet of the retainer, if desired. The biasing members are noted as being carried by the retainers as shown and are not directly connected to the movable pane such as by an adhesive or bonding agent. Thus, the primary forces from engagement of the biasing members with the guide rail are borne by the retainer and not directly by the movable pane (e.g. the glass of the movable pane). Forces transferred to the movable pane through the retainer are distributed along a greater length of the movable pane as the retainer preferably, in at least some implementations, extends along the full length of the movable pane or at least a majority of the length of the movable pane.

While the forms of the invention herein disclosed constitute presently preferred embodiments, many others are possible. It is not intended herein to mention all the possible equivalent forms or ramifications of the invention. It is understood that the terms used herein are merely descriptive, rather than limiting, and that various changes may be made without departing from the spirit or scope of the invention.

1. A window assembly for a motor vehicle, comprising:
a guide rail having at least one wall that defines at least part of a guide track;
a movable pane associated with the guide rail and movable relative to the guide track along a path of movement defined by and between a closed position and a fully open position;
a retainer coupled to the movable pane and movable with the movable pane, the retainer being located at least partially within the guide track and moveable along the guide track, the retainer including at least one biasing member that is engaged with the wall along the path of movement to limit movement of the retainer relative to the guide rail.

2. The assembly of claim 1 wherein the guide rail includes at least two walls that define at least part of the guide track and the biasing member is engaged with a first one of the at least two walls and biases the retainer away from the first one of the at least two walls and into engagement with a second one of the at least two walls.

3. The assembly of claim 2 wherein the retainer is engaged with both of the first and second of the at least two walls throughout movement of the movable pane along the path of movement.

4. The assembly of claim 1 wherein the retainer includes a cavity in which a portion of the movable pane is received and the cavity includes a laterally and vertically extending end wall facing a peripheral edge of the movable pane and a pair of vertically and longitudinally extending side walls connected together by the end wall and each side wall faces an opposed face of the movable pane, and wherein the biasing member extends away from the cavity and provides a force acting vertically on the guide rail.

5. The assembly of claim 1 wherein the retainer includes a cavity in which a portion of the movable pane is received and the cavity includes a laterally and vertically extending end wall facing a peripheral edge of the movable pane and a pair of vertically and longitudinally extending side walls connected together by the end wall and each side wall faces an opposed face of the movable pane, and wherein the biasing member extends away from the cavity and provides a force acting laterally on the guide rail.

6. The assembly of claim 4 wherein the guide rail includes a laterally extending flange defining part of the guide track and having an upper surface and a lower surface and the biasing member engages at least one of the upper surface and the lower surface.

7. The assembly of claim 1 wherein multiple biasing members are provided spaced apart from each other with each biasing member arranged to engage the guide rail.

8. The assembly of claim 5 wherein the biasing member has two ends and is connected at both ends to a side wall of the retainer, and a portion of the biasing member between the two ends is outwardly bowed from the sidewall to which the biasing member is connected.

9. The assembly of claim 5 wherein the biasing member has a base connected to one of the side walls of the retainer and a free end spaced from the base, and from the base to the free end the biasing member extends outwardly away from the sidewall to which the biasing member is connected.

10. The assembly of claim 5 wherein the biasing member is connected to and extends along one of the side walls of the retainer along the entire length of the biasing member, and the biasing member has an outer surface that is located further away from the cavity than the sidewall to which the biasing member is connected.

11. The assembly of claim 5 wherein the retainer includes a lower wall located below the cavity and wherein the biasing member is vertically spaced from the lower wall.

12. The assembly of claim 5 wherein the biasing member is carried by a side wall of the retainer at or adjacent to an upper surface of the sidewall.

13. A window assembly for a motor vehicle, comprising:
a guide rail having a guide track defined at least in part by opposed side walls and an upwardly facing surface disposed between the side walls;
a movable pane associated with the guide rail and movable relative to the guide track along a path of movement defined by and between a closed position and a fully open position;
a retainer coupled to the movable pane and movable with the movable pane, the retainer being located at least partially within the guide track and moveable along the guide track, the retainer including a body received between the side walls of the guide rail and having at least one biasing member that is engaged with one side wall or the upwardly facing surface along at least part of the path of movement to limit movement of the retainer relative to the guide rail.

14. The assembly of claim 13 wherein the biasing member is cantilevered from the body.

15. The assembly of claim 13 wherein the biasing member is coupled to the body at two locations and a gap is provided between the two locations and a portion of the biasing member between the two locations moves relative to the gap.

16. The assembly of claim 13 wherein the side walls extend longitudinally along the path of travel of the movable pane and the biasing member extends laterally into contact with one of the side walls.

17. The assembly of claim 16 wherein multiple biasing members are provided spaced along a longitudinal length of the body.

18. The assembly of claim 13 wherein the lower surface extends longitudinally along the path of travel of the movable pane and the biasing member extends vertically into contact with the lower surface.

19. The assembly of claim 18 wherein the lower surface includes an upwardly facing surface and a downwardly facing surface and the biasing member engages one of the upwardly facing surface or the downwardly facing surface.

20. The assembly of claim 13 wherein the retainer includes a vertically extending leg and the biasing member extends from the leg.

21. The assembly of claim 20 wherein the leg includes a laterally extending foot and the biasing member extends from the foot.

22. A retainer for a movable pane of a window assembly, comprising:
a body having an upper surface, a lower surface and a pair of opposed side walls extending vertically between the upper surface and lower surface and longitudinally along at least a portion of a length of the body, and a pair of legs extending from the lower surface and including at least one laterally extending foot spaced from the lower surface,
the body includes a cavity formed in at least one of the upper surface and the lower surface, the cavity adapted to receive part of the movable pane and being defined by a pair of longitudinally and vertically extending side walls and a pair of laterally and vertically extending end walls connected to the side walls, and
a biasing member connected to the body and extending away from a portion of the body to which the biasing member is connected, the biasing member is flexible and resilient and adapted to engage a guide rail of the window assembly and to resiliently flex toward the portion of the body to which the biasing member is connected.

23. The retainer of claim 22 wherein the biasing member is arranged to flex in a lateral direction relative to the body.

24. The retainer of claim 22 wherein the biasing member is arranged to flex in a vertical direction relative to the body.
